(19) United States
(12) Patent Application Publication
(10) Pub. No.: US 2014/0234615 A1
(43) Pub. Date: Aug. 21, 2014

(54) Fuel Dispenser Protectors for Digital Display Screens and Graphic Panels

(71) Applicant: Senyan Meng, Montclair, CA (US)

(72) Inventor: Senyan Meng, Montclair, CA (US)

(21) Appl. No.: 13/900,026

(22) Filed: May 22, 2013

Related U.S. Application Data
(60) Provisional application No. 61/766,314, filed on Feb. 19, 2013.

(51) Int. Cl. B32B 7/12

(52) U.S. Cl. CPC B32B 7/12
USPC 428/332; 428/537.5; 428/480

(57) ABSTRACT

A fuel dispenser protector for protecting digital display screens and graphic panels on a fuel dispenser from vandalism and graffiti. The transparent protector includes an adhesive substance connected to the transparent protector. A paper backing covers the adhesive. In a preferred embodiment the transparent is pre-cut to match the size of the digital display screen or graphic panel that it is covering.

The present invention relates to fuel dispensers, and in particular, to fuel dispenser display screens and graphic panels. This application claims the benefit of Provisional Application No. 61/766,314 filed Feb. 19, 2013, which is incorporated by reference herein.

### BACKGROUND OF THE INVENTION

Fuel dispensers, also commonly referred to as fuel pumps or gas pumps, are well known. Fuel dispensers for road vehicles (such as automobiles, motorcycles and trucks) are very common throughout the roads of the United States and the rest of the world. Gas stations are liberally positioned so that drivers have a station nearby when it is necessary to refuel their vehicle.

Fuel dispensers are very expensive items and their maintenance can be a significant cost to a gas station owner. In addition to operational mechanical failures, many gas station owners must contend with vandalism because fuel dispensers are a common target for gang graffiti.

FIG. 1 shows prior art fuel dispenser 1. Fuel dispenser 1 is the Gilbarco B-78 fuel dispenser manufactured by Gilbarco, Inc. with offices in Greensboro, N.C. Fuel dispenser 1 includes multiple acrylic digital screen displays 2-7. A vandal or graffiti artist typically will attack one or more of digital screen displays 2-7. The vandal may either paint the digital screen display or he may scratch graffiti into the digital screen. After the screen becomes damaged the gas station owner is forced to replace the screen so that his customers can read the digital information that is displayed. It is very expensive to replace a digital screen.

Poly(methyl methacrylate) (PMMA) is a transparent thermoplastic, often used as a lightweight or shatter-resistant alternative to glass. Although it is not technically a type of glass, the substance has sometimes historically been called acrylic glass or just acrylic.

### Graphic Panels

Graphic Panels for fuel dispensers (also know as gas pump overlays) are known and are commonly used for displaying the trademark of the owner of the fuel dispenser. For example, a graphic panel may display the Shell®, Exxon®, Mobil®, or Arco® trademark. A prior art graphic panel 30 with cut out areas 31 is shown in FIG. 1B. Graphic panel 30 is fabricated from thin metal or a similar lightweight material. It is snap fitted onto a gas pump. A graphic panel is built to a specific size so that it can be easily replaced as necessary. Graphic panels are exposed to weather, which can cause them to fade. They also may be inadvertently damaged due to normal gas pump use. Unfortunately, they are also frequent targets of vandals and may be scratched or painted by a vandal. Graphic panels are expensive and time consuming to replace.

What is needed is a way to protect fuel dispenser digital display screens and graphic panels from vandals.

### SUMMARY OF THE INVENTION

The present invention provides a fuel dispenser protector for protecting digital display screens and graphic panels on a fuel dispenser from vandalism and graffiti. The transparent protector includes an adhesive substance connected to the transparent protector. A paper backing covers the adhesive. In a preferred embodiment the transparent is pre-cut to match the size of the digital display screen or graphic panel that it is covering.

### BRIEF DESCRIPTION OF THE DRAWINGS

FIG. 1 shows a prior art fuel dispenser.

FIG. 1B shows a prior art graphic panel.

FIG. 2 shows a preferred screen protector kit.

FIG. 3 shows items from the screen protector kit.

FIG. 4 shows a presser with flat edged 21.

FIG. 5 shows screen protector 16 with paper backing 16b.

FIG. 6 shows screen protector 16 covering screen 4.

FIG. 7 shows fuel dispenser 1 with its screens covered by screen protectors 11-16.

FIGS. 8-10 show the utilization of transparent protectors for graphic panels.

### DETAILED DESCRIPTION OF THE PREFERRED EMBODIMENTS

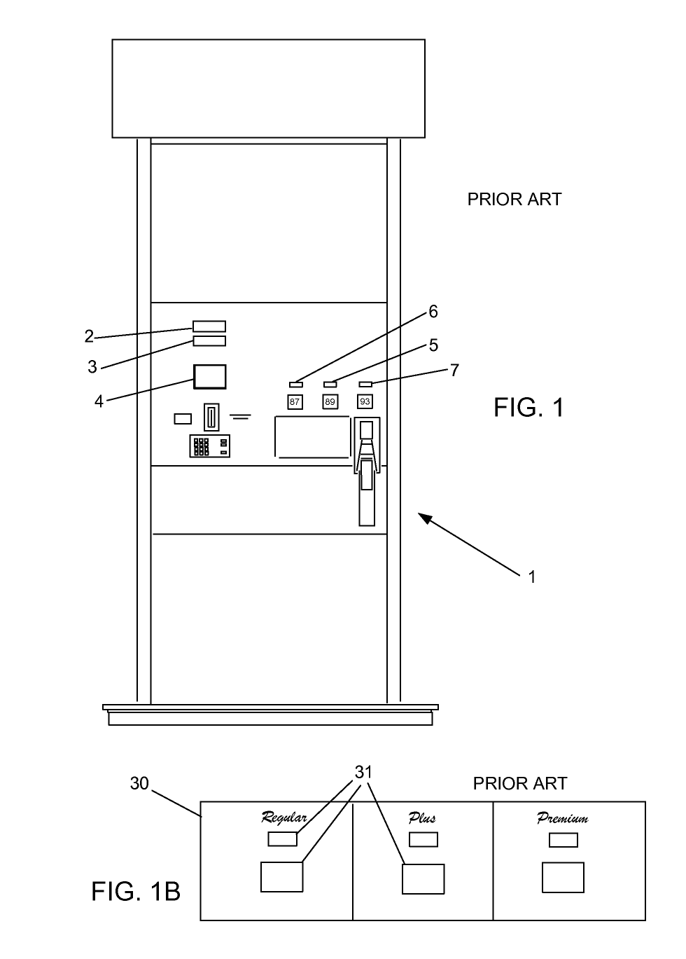

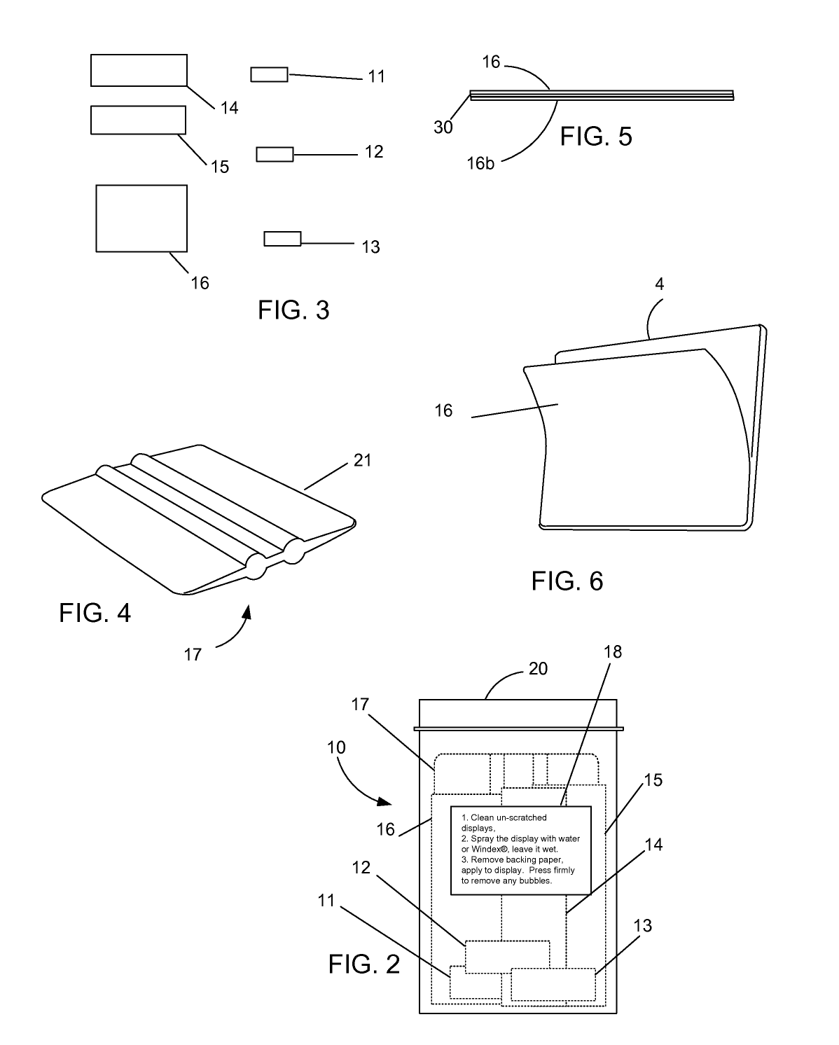

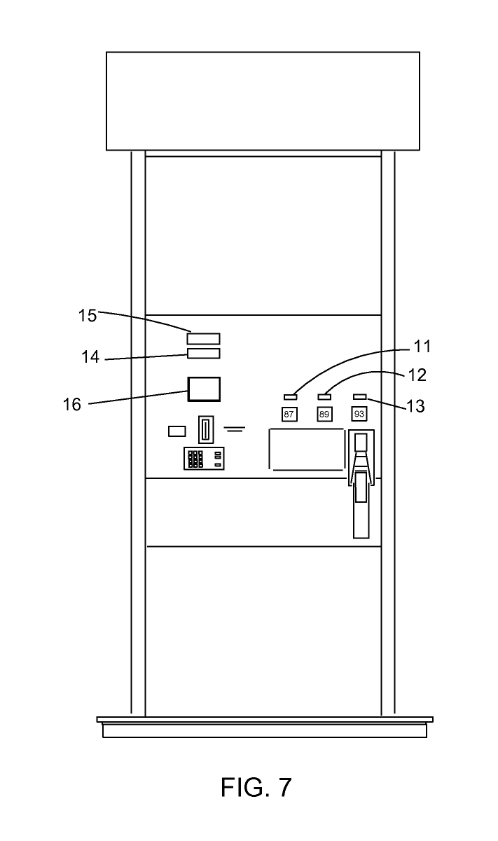

FIG. 2 shows a preferred fuel dispenser screen protection kit 10. A gas station owner will preferably purchase multiple kits 10 to protect his display screens, such as display screens 2-7 (FIG. 1). The following items are preferably included inside kit 10: protective transparent polyester screen protectors 11-16 (see also FIG. 3), written instructions 18 and plastic presser 17 (see also FIG. 4) with pressing edge 21. In the event of vandalism, the screen protector provides a sacrificial layer so that the underlying surface is not damaged. Depending on his needs the gas station owner may decide to purchase additional kits or he may only need to purchase specific protector sizes if he finds that certain areas on the fuel dispenser are more prone to vandalism and graffiti than others.

The following is an explanation of how to install screen protector 16 over screen 4 (FIG. 1): First, the installer cleans screen 4 with water or any commercially available glass cleaner. Then the installer removes paper backing 16b from screen protector 16 (FIG. 5). Screen protector 16 preferably includes adhesive 30 so that screen protector 16 will readily adhere to screen 4. After the paper backing has been removed, the installer places screen protector 16 against screen 4 (FIG. 6). The installer is careful to properly align screen protector 16 so that screen 4 is completely covered. The goal of the installer is to make it appear as though nothing is protecting screen 4 so that the vandal is tricked. After screen protector is adhered to screen 4, the installer will use presser 17 (FIG. 4) to press the top of screen protector 16 to remove any imperfections and to press out any bubbles. After screen protector 16 has been installed, the installer will install the other screen protectors 11-15 over screens 2,3,6,5 and 7 in a similar fashion.

The screen protectors are preferably pre-cut to size depending on the model of the fuel dispenser. This is important because it ensures that the fuel dispenser display screens will be thoroughly covered by the screen protectors, (i.e., the screen protectors will not be too small or too big). If the screen protectors are not the correct size it will be easier for the vandal to recognize that the display screens are protected. The vandal may then decide to try to peel off the display screens.

Also, in a preferred embodiment the screen protectors are fabricated from hard coated polyester and have a thickness of approximately 10 mil. By having sufficient thickness and hardness, it will be more difficult for the vandal to recognize that the acrylic screen is covered by a screen protector. Also a thick and hard screen protector will protect the screen better if a vandal attempts to scratch graffiti into the screen. It is important that the vandal does not recognize that the screen is covered by a screen protector so that the vandal does not try to peel off the protector.

After a vandal carves into or paints over a fuel dispenser protector screen cover, the owner of the fuel dispenser merely needs to peel off the ruined screen protector and install a new one.

It should be recognized there are many types and brands of fuel dispenser pumps, each with uniquely sized display screens. Some other fuel dispenser models are: Gilbarco Encore 500, Gilbarco Advantage, Gilbarco Encore 300, Dresser Wayne Ovation, Dresser Wayne Ovation LX, and Dresser Wayne Vista 390. There are also many others. For each of these dispensers, and for others not mentioned, the fuel dispenser owner will preferably purchase a fuel dispenser screen protection kit that includes screen protectors cut to the correct size in a fashion similar to that described above.

### Protectors for Graphic Panels

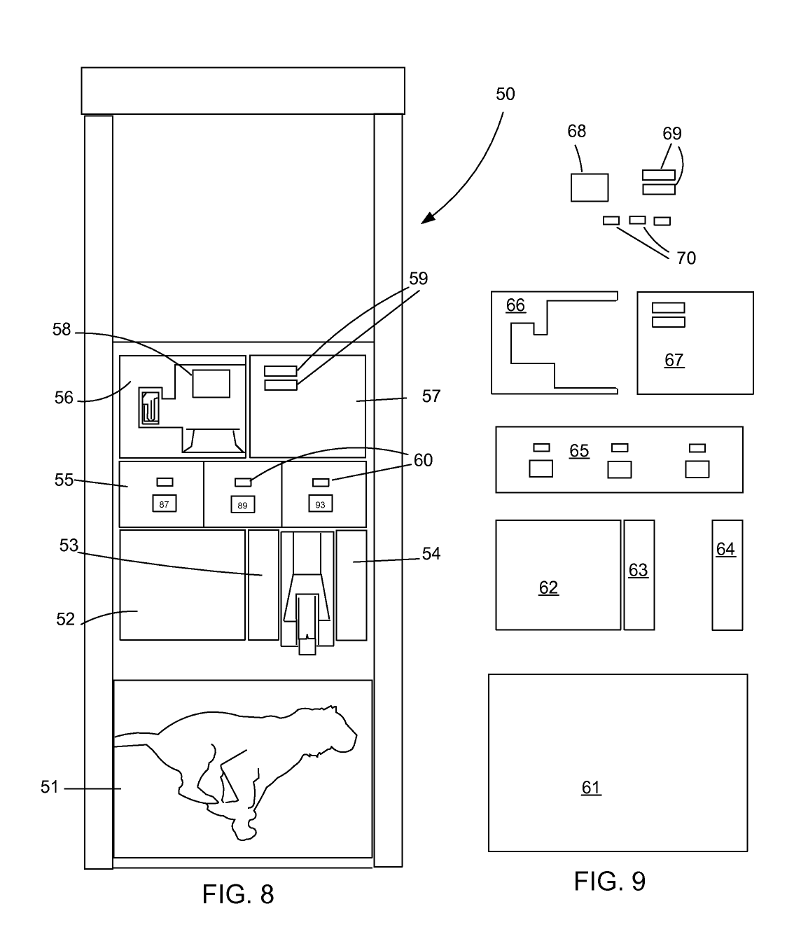

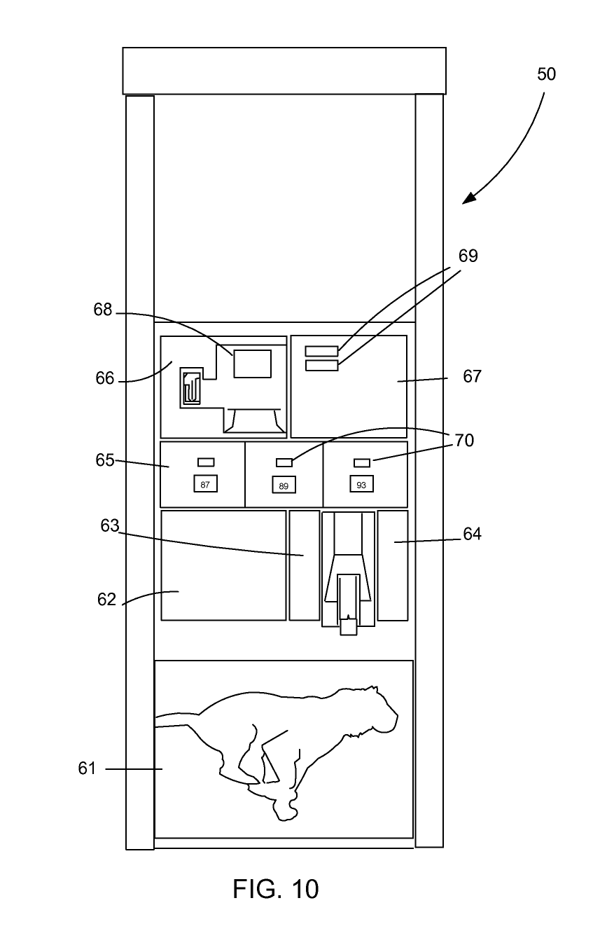

In another preferred embodiment, screen protector starter kit 10 includes transparent protectors for graphic panels. In a preferred embodiment, each transparent protector is custom sized so that it fully covers a corresponding graphic panel. For example, FIG. 8 shows prior art fuel dispenser 50. Fuel dispenser 50 includes graphic panels 51-57 and screens 58-60. Accordingly, kit 10 now includes graphic panel transparent protectors 61-67 and screen transparent protectors 68-70. In order to protect fuel dispenser 50, the fuel dispenser owner shall install graphic panel transparent protectors 61-67 and screen transparent protectors 68-70 over the appropriately sized graphic panels 51-57 and screens 58-60 as shown in FIGS. 8 and 10.

Although the above-preferred embodiments have been described with specificity, persons skilled in this art will recognize that many changes to the specific embodiments disclosed above could be made without departing from the spirit of the invention. For example, starter kit 10 may also include a cleaning rag and cleaning fluid to be used for cleaning the digital display screens and graphic panels prior to installation of the protectors. Therefore, the attached claims and their legal equivalents should determine the scope of the invention.

What is claimed is:

1. A fuel dispenser protector for protecting either digital display screens or graphic panels on a fuel dispenser from vandalism and graffiti, said fuel dispenser protector comprising:
A. at least one transparent protector, comprising:
1) an adhesive substance connected to said transparent protector, and
2) a paper backing covering said adhesive.

2. The fuel dispenser protector as in claim 1, wherein said at least one transparent protector comprises:
A. at least one transparent protector for digital display screens, and
B. at least one transparent protector for graphic panels.

3. The fuel dispenser protector as in claim 1, wherein said fuel dispenser comprises a plurality of display screens and a plurality of graphic panels, wherein said at least one transparent protector is a plurality of transparent protectors that are pre-cut to a size so that they match the size of said plurality of screens and said plurality of graphic panels.

4. The fuel dispenser protector as in claim 1, wherein said at least one transparent protector is fabricated from transparent hard coated polyester.

5. The fuel dispenser protector as in claim 1, wherein said at least one transparent protector has a thickness of at least 10 mil.

6. The fuel dispenser protector as in claim 1, wherein said at least one transparent protector is a plurality of transparent protectors is sold as part of a kit, said kit further comprising:
A. a set of written instructions for proper installation of said plurality of transparent protectors,
B. a cleaning rag,
C. cleaning fluid, wherein said cleaning rag and cleaning fluid are for cleaning said digital display screens and said graphic panels prior to installation of said plurality of transparent protectors,
D. a pressing device for pressing out air bubbles during the installation process, and
E. a container for containing said plurality of transparent protectors, said written instructions, said cleaning rag, said cleaning fluid, and said pressing device.
